(19) United States
(12) Patent Application Publication
(10) Pub. No.: US 2005/0159035 A1
(43) Pub. Date: Jul. 21, 2005

(54) Lift-up mini secure digital card connector

(75) Inventor: Hsine-Kuang Shih, Taoyuan City (TW)

Correspondence Address: BACON & THOMAS, PLLC, 625 SLATERS LANE, FOURTH FLOOR, ALEXANDRIA, VA, 22314, US

(73) Assignee: P-TWO INDUSTRIES INC., Taoyuan City (TW)

(21) Appl. No.: 10/910,655

(22) Filed: Aug. 4, 2004

(30) Foreign Application Priority Data
Jan. 20, 2004 (TW) 093101676

(51) Int. Cl. H01R 13/62

(52) U.S. Cl. 439/159

(57) ABSTRACT

A lift-up miniSD memory card connector comprises an insulating body, a movable lift-up lid and eleven terminal pins; wherein the movable lift-up lid has a drawer type space for accommodating a miniSD memory card inserted in any angle to greatly reduce the operating space of the miniSD memory card. After a miniSD memory card is inserted into the drawer type space of the movable lift-up lid, the movable lift-up lid will be disposed above the guiding track sections on both sides of the signal contact section of the miniSD memory card by means of a blocking panel individually disposed on the left and right sides of the movable lift-up lid for guiding the miniSD memory card to be inserted precisely into the movable lift-up lid. This kind of lift-up miniSD memory card connector features its small operating space which can be used extensively in multimedia mobile phones digital cameras MP3 players, recorders and navigation systems. In addition, this kind of lift-up miniSD memory card connector can come with a detector, so that the detector is used to detect and confirm whether or not a miniSD memory card is inserted into the lift-up miniSD memory card connector and whether or not the inserted miniSD memory card is in the normal operation status.

### BACKGROUND OF THE PRESENT INVENTION

1. Field of the Present Invention

The present invention relates to a lift-up memory card connector, more particularly to a connector specially used in a miniSD memory card (mini secure digital card).

2. Description of Prior Act

A flash memory card shown in FIG. 1 is also known as a miniSD memory card 60. The miniSD memory card 60 is a new model having the dimension of 20 mm×21.5 mm×1.4 mm, and its area is about the area of half of a thumb.

At present, a miniSD memory card 60 has a storage capacity of up to 256 megabytes (MB) or more. As to the structure, the miniSD memory card 60 comprises a signal contact section 61 having eleven signal lines at its bottom and a guide track section 63 disposed on both sides of the signal contact section 61, and particularly having an opening with a wedge-shaped surface 62 to define a foolproof structure for the miniSD memory card 60.

Compared with the general standard SD memory cards having nine signal lines and the dimensions of 32 mm×24 mm×2.1 mm, the miniSD memory card 60 has a much smaller size, and thus can save at least 40% of the area of the printed circuit board of the present SD memory card.

When the miniSD memory card 60 is designed and used on a portable device, the volume will be decreased accordingly to save at least 60% of the volume of the present SD memory card, and the miniSD memory card 60 provides two more signal lines reserved for future expansion. For example, these additional signal lines may be used for the connection for the near-distance wireless communications of a non-contact type IC.

Since the model of this miniSD memory card 60 has a compact size and greatly saves area and volume, therefore the miniSD memory card 60 is more applicable for the applications on palm electronic products including mobile phones, and particularly applicable for the storage of a large quantity of data for mobile phones and the SD interface used for the miniSD memory card 60 is the same as the present SD memory card. Regardless of hardware or software, the miniSD memory card 60 is compatible with the present SD memory card. Therefore, the U.S. SD Memory Card Association has approved the miniSD memory card standard as a standard extension of the present SD memory card.

After mobile phones have adopted the miniSD memory card 60 for data storage, the new model of mobile phones not only increases the memory capacity, but also provides exciting multimedia functions including digital camera, video information retrieval, MP3 playback, electronic game, personal information management (PIM), e-mail, voice mail and Internet communication. Further, the miniSD memory card 60 is light, thin, short, and small, and thus can satisfy the market requirements on the compactness of mobile phones.

In view of the description above, a miniSD memory card connector is invented according to the miniSD memory card standard to cater to the future trend of the extensive application of the miniSD memory card 60.

### SUMMARY OF THE PRESENT INVENTION

It is therefore a primary objective of the present invention to provide a lift-up miniSD memory card connector for miniSD memory card and greatly reduce the operating space required for connecting the miniSD memory card, and thus extensively be used in the multimedia mobile phones, digital cameras, MP3 players, recorders and navigation systems, such that this electronic equipment can use the miniSD memory card for storing data.

The secondary objective of the present invention is to provide a lift-up miniSD memory card connector which comprises an insulating body, a movable lift-up lid and eleven terminal pins; wherein the movable lift-up lid has a drawer type space for accommodating a miniSD memory card inserted in any angle to greatly reduce the operating space of the miniSD memory card. When the movable lift-up lid is pressed downward and closed such that the insulating body is latched, the signal contact section of the miniSD memory card is electrically connected to the terminal pins of the connector.

A further objective of the present invention is to provide a lift-up miniSD memory card connector has an asymmetrical structure disposed on both sides of the movable lift-up lid of the connector according to the standard and specifications of the miniSD memory card in order to prevent the wrong insertion of the signal contact section of the miniSD memory card. In the meantime, after the miniSD memory card is inserted into the drawer type space of the movable lift-up lid, the movable lift-up lid disposes its blocking panels on both sides precisely across the top of a guide track section on both sides of the signal contact section of the miniSD memory card to guide the miniSD memory card into the movable lift-up lid.

Another further objective of the present invention is to provide a lift-up miniSD memory card connector which further comprises a detector for detecting and confirming whether or not a miniSD memory card is inserted into the lift-up miniSD memory card connector and whether or not the inserted miniSD memory card is in the normal operation status. If no miniSD memory card is inserted, the detector of the connector is not electrically connected and thus will show that no miniSD card is inserted. If a miniSD memory card is inserted correctly into the movable lift-up lid of the connector and the lift-up lid is closed properly onto the correct position of the connector, then the detector of the connector is electrically connected and thus will show that a miniSD memory card is inserted into the connector and operated in the normal condition.

### BRIEF DESCRIPTION OF THE DRAWING FIGURES

FIG. 1 is a perspective view of the overall structure of a new model of the miniSD memory card 60 according to the present invention.

FIG. 2 is a perspective view of a miniSD memory card connector 10 according to a first preferred embodiment of the present invention when its movable lift-up lid 30 is lifted up for use.

FIG. 3 is an exploded view of the miniSD memory card connector 10 according to a first preferred embodiment of the present invention.

FIG. 4 is a longitudinal cross-sectional view of the movable lift-up lid 30 as depicted in FIG. 3 illustrating the lift-up lid 30 having a drawer type space and a bending board disposed on the right side 32 having a press board 32b facing the internal space 32a of the bending board and being curved upward slightly according to the present invention.

FIG. 5 is an illustrative view of the miniSD memory card 60 being correctly placed in the movable lift-up lid 30 and ready to be closed for its use according to the first preferred embodiment of the present invention.

FIG. 6 is an illustrative view of the process of closing the lift-up lid as depicted in FIG. 5 according to the present invention.

FIG. 7 is an illustrative view of the movable lift-up lid 30 being closed as depicted in FIG. 5 and pushed toward together with the miniSD memory card 60 to latch and fix the insulating body 20 in place according to the present invention.

FIG. 8 is an illustrative view of the movable lift-up lid 30 being closed as depicted in FIG. 7 to latch and fix the insulating body 20 in place and the miniSD memory card 60 being electrically connected to the signal contact section 61 and the miniSD memory card connector 10 according to the present invention.

FIG. 9 is a perspective view of the overall structure of the miniSD memory card 60 and its application according to a second preferred embodiment of the present invention.

FIG. 10 is an exploded view of the miniSD memory card connector 10 according to a second preferred embodiment of the present invention.

FIG. 11 is a cross-sectional view of an enlarged Section 11-11 as depicted in FIG. 9 according to the present invention.

FIG. 12 is an illustrative view of the movable lift-up lid 30 being closed as depicted in FIG. 9 and pushed forward together with the miniSD memory card 60 to a correct position for its use according to the present invention.

FIG. 13 is a cross-sectional view of an enlarged section 13-13 as depicted in FIG. 12 illustrating that the signal contact section of the miniSD memory card presses the bending section of the detector terminal to electrically connect the electric contact section of the detector terminal with a lock plate according to the present invention.

FIG. 14 is a cross-sectional view of an enlarged Section 14-14 as depicted in FIG. 12 illustrating that the electric contact section of the detector terminal 70 is electrically connected 72 with the latch plate 55 according to the present invention.

### DETAILED DESCRIPTION OF THE PREFERRED EMBODIMENTS

Referring to FIGS. 2 to 5, a miniSD memory card connector 10 disclosed in the drawings is a first preferred embodiment of the present invention. The miniSD memory card connector 10 comprised an insulating body 20, a movable lift-up lid 30 having a draw function for placing a miniSD memory card 60 and eleven terminal pins 40.

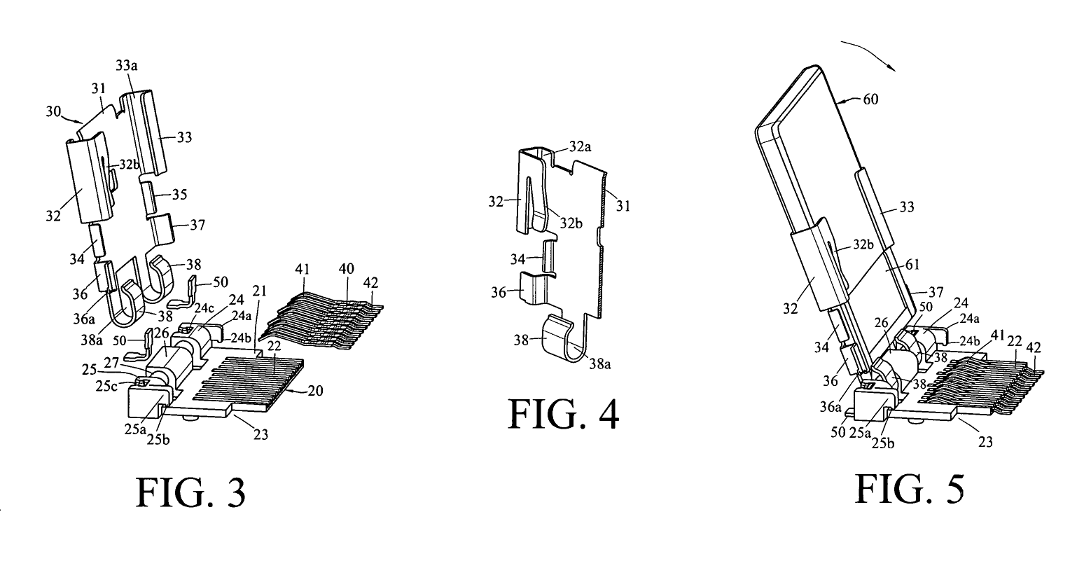

The insulating body 20 comprises a flat substrate 21 extended forward as shown in FIG. 3, eleven grooves 22 disposed on the surface of the substrate 21 for receiving eleven terminal pins 40, and an opening 23 defined on both sides of the front section of the substrate 21. The purpose of the insulating body 20 resides on after the movable lift-up lid 30 is closed as shown in FIGS. 7 and 8, the right inverted L-shape bending board 32 and the left bending board 33 disposed on both sides of the movable lift-up lid 30 having the drawer function will not collide with the surface of the substrate 21 of the insulating body 20 and move back and forth in the space of the opening 23 of the substrate 21. In other words, the movable lift-up lid 30 is pushed forward or pulled backward as indicated by the arrow direction of the figures.

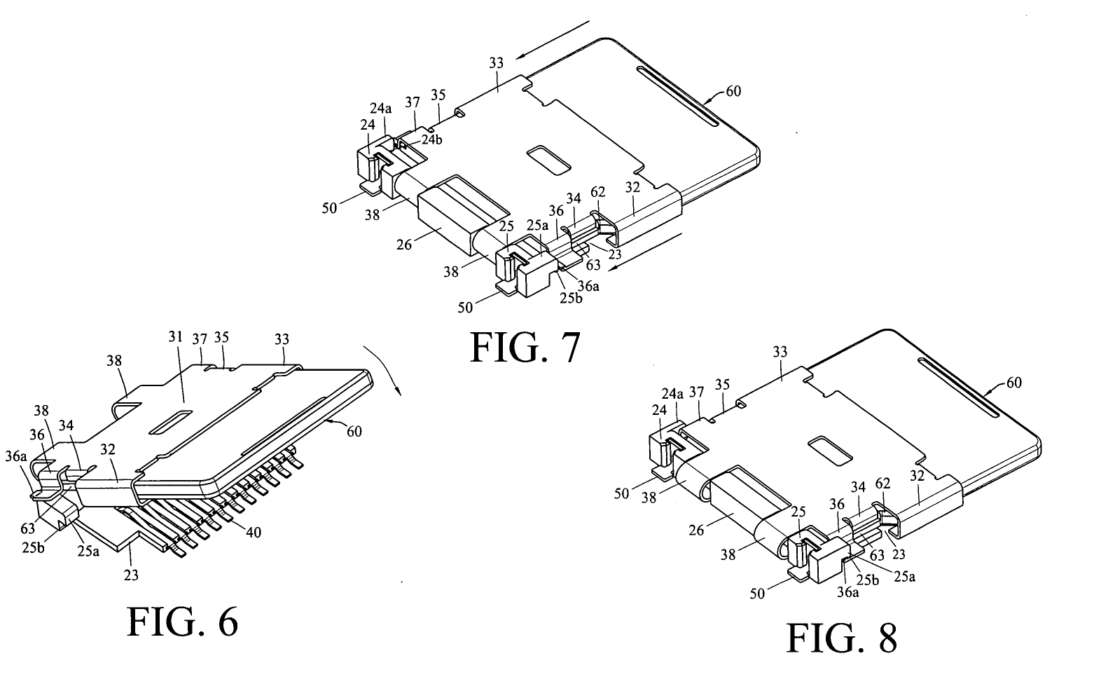

After eleven terminal pins 40 are fixed on the surface of the substrate 21 of the insulating body 20, a bending section 41 at the front section of each terminal pin 40 is protruded from the surface of the substrate 21 and keeps its resilience, and the pin section 42 at the rear section of each terminal pin 40 as shown in FIG. 2 is exposed. If a miniSD memory card connector 10 according to the present invention is used, the terminal pins are soldered on the circuit board. After a miniSD memory card 60 is inserted into the lift-up lid 30 and the lift-up lid 30 is closed as shown in FIGS. 5 and 6, the eleven signal lines at the signal contact section 61 of the miniSD memory card 60 will immediately constitute a good electric connection with the eleven terminal pins 40 of the insulating body 20.

Further, three platforms having a partial height protruded upward from the rear side of the substrate 21 of the insulating body 20 and being disposed at an interval with each other in the direction as shown in the figures. The three platforms include a left platform 24, a right platform 25 and a middle platform 26, wherein a coaxial axle rod 27 is disposed between the left platform 24 and the middle platform 26 as well as between the right platform 25 and the middle platform 26 such that the two axle rods 27 are used as fulcrums for a short linear reciprocal displacement.

A first bracket 24a is extended from and disposed on the external side of the left platform 24 and a first rib 24b is extended vertically downward and disposed on the bottom surface of the first bracket 24a; similarly, a second bracket 25a is extended from and disposed on the external side of the right platform 25 and a second rib 25b is extended vertically downward and disposed on the bottom surface of the second bracket 25a. To cater the asymmetric design of the left and right sides of the miniSD memory card 60, the movable lift-up lid 30 according to the present invention is corresponsive with such asymmetric design, and thus in the structure of the movable lift-up lid 30, the thickness of the second bracket 25a of the right platform 25 of the insulating body 20 is designed to be thicker than the first bracket 24a of the left platform 24.

Referring to FIGS. 3 and 4 for the movable lift-up lid 30, which comprises a lid panel 31 and a L-shaped bending board disposed at the front section of both sides of the lid panel 31. In other words, an L-shaped right bending board 32 and a left bending board 33 are disposed on the right and left sides of the movable lift-up lid 3 respectively. However, the right bending board 32 and the left bending board are flat boards and correspondingly face the internal side of the movable lift-up lid 30, such that the internal space 32a of the right bending board 33 faces the corresponding internal side of the movable lift-up lid 30 to define a space with a drawer function for receiving the insertion and disposition of a miniSD memory card.

In the meantime, a press board 32b is stamped from a bottom panel of the right bending board 32 or the left bending board 33 by a stamping technology as illustrated by the right bending board 32 in the figures. The press board 32b is curved slightly upward and faces the internal space 32a of the right bending board 32, and thus maintains its resilience. When the miniSD memory card 60 is placed into the movable lift-up lid 30, the press board 32b produces an appropriate pressing force onto the miniSD memory card 60 such that the surface of the miniSD memory card can be attached flatly on the surface of the lid panel 31 of the movable lift-up lid and the miniSD memory card 60 can be successfully inserted in the movable lift-up lid 30.

A right blocking panel 34 and a left blocking panel 35 are protruded downwardly from the middle section of both the left and right sides of the lid panel 31 of the movable lift-up lid 30, but the stamped position of the right blocking panel 34 is deeper into the lid panel 31 of the movable lift-up lid 30 than the stamped position of the left blocking panel 35 as shown in FIGS. 7 and 8, and thus asymmetric structures are formed on both sides.

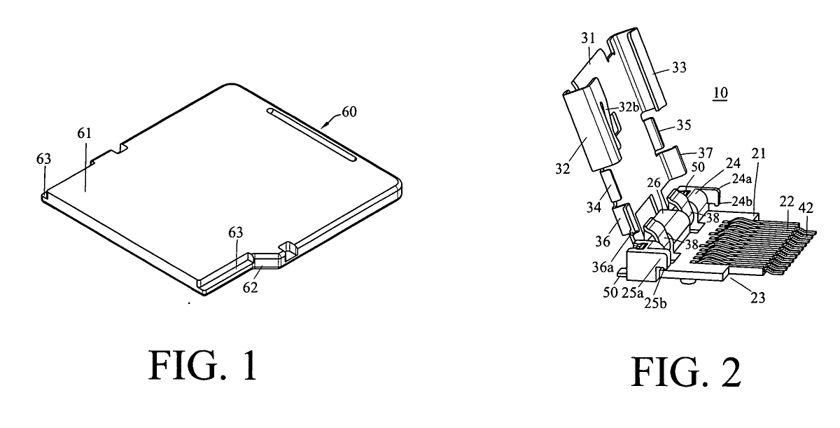

In other words, the miniSD memory card 60 as shown in FIG. 1 defines a guide track section 63 disposed on both sides of the signal contact section 61 and the top of one side of the guide track section 63 defines a foolproof structure having an opening with a wedge-shaped surface 62 and asymmetric structures on both sides. Therefore, the designed position and height of the right blocking panel 34 and the left blocking panel 35 of the movable lift-up lid 30 must comply with the miniSD memory card standard and specifications to have an asymmetric structure on both sides.

In FIGS. 6 to 8, after the miniSD memory card 60 is placed into the drawer type space of the movable lift-up lid 30, the right blocking panel 34 and the left blocking panel 35 of the movable lift-up lid 30 according to the present invention are disposed precisely across the guide track section 63 on both sides of the miniSD memory card 60 to provide the function of guiding the miniSD memory card 60 to be inserted correctly in the movable lift-up lid 30, and the position of the right blocking panel 34 constitutes a foolproof structure for the miniSD memory card 60 and provides a way for the users to examine whether or not the miniSD memory card 60 is inserted correctly, since the structures of both sides of the miniSD memory card 60 are asymmetric. If the miniSD memory card 60 is installed in the reverse direction, then after the miniSD memory card 60 is installed into the drawer type space of the movable lift-up lid 30, the front end of the signal contact section 61 will be blocked by the right blocking panel 34 to prevent its further insertion. On the other hand, if the miniSD memory card 60 is inserted correctly into the drawer type space of the movable lift-up lid 30, then the miniSD memory card 60 will be guided by the right blocking panel 34 and the left blocking panel 35 of the movable lift-up lid 30 to continue its entrance into the interior until the right blocking panel 34 touches the wedge-shape surface 62 of the miniSD memory card 60. At that time, the miniSD memory card is fixed into the correct position.

Two latch brackets 38 are protruded from the bottom of the lid panel 31 of the miniSD memory card 30 at the positions corresponding to two axle rods 27 of the insulating body 20 as shown in FIG. 3. The latch bracket 38 has a hook groove 38a including an arc section and a linear section; when the arc section of the latch bracket of the movable lift-up lid touches the axle rod 27 of the insulating body 20, the movable lift-up lid 30 can be rotated in 180 degrees and either lifted up or closed and provides the insertion of the miniSD memory card 60 at any angle; and the linear section of the latch bracket 38 constitutes the track for the linear movement of the movable lift-up lid 30.

In FIGS. 5 to 7, after the miniSD memory card 60 is installed to the movable lift-up lid 30 and the movable lift-up lid containing the miniSD memory card 60 is closed, the backside of the signal contact section 61 of the miniSD memory card 60 will be in contact with the terminal pin 40 of the insulating body 20 and thus constitute a good electric connection. At that time, an L-shaped right latch board 36 and a left latch board 37 are protruded downward from the rear section of both sides of the lid panel 30 of the movable lift-up lid 30 in order to secure the movable lift-up lid 30 in place, but the horizontal plates of the right latch board 36 and the left latch board 37 face towards the external side of the movable lift-up lid 30, and a tenon rib 36a is disposed on the surface of the horizontal plate as shown in FIGS. 7 and 8. When the movable lift-up memory lid 30 together with the miniSD memory card 60 are closed downward to push both the movable lift-up lid 30 and the miniSD memory card 60 forward, so that the tenon rib 36a of the right latch board 36 of the movable lift-up lid 30 is latched into the rib 25b of the right platform 25 of the insulating body 20 while the tenon rib 36a of the left latch board 37 of the movable lift-up lid is also latched into the rib 24b of the left platform 24 of the insulating body 20, so that the movable lift-up lid 30 is latched by the right platform 25 and the left platform 24 of the insulating body 20 and cannot be lifted up, so that the signal contact section 61 of the miniSD memory card 60 constitute a good electric connection with the terminal pins 40.

If it is necessary to remove the miniSD memory card 60, the operation will be reversed by pulling out the movable lift-up lid 30 together with the miniSD memory card 60 first to separate the movable lift-up lid 30 from the latch of the right platform 25 and the left platform 24 of the insulating body 20, and then lift up the movable lift-up lid 30 and take the miniSD memory card 60 out.

Further in FIG. 3, a slot 25c is disposed on the right platform 25 of the insulating body 20 and a slot 24c for inserting a lock plate 50 therein. If a miniSD memory card connector 10 is used, the pin section 42 at the rear section of the terminal pin 40 and the lock plate 50 on both sides of the insulating body 20 are soldered on the circuit board to fix the miniSD memory card connector 10 on the circuit board.

Referring to FIGS. 5 and 8 the miniSD memory card connector 10 is soldered on the printed circuit board of a mobile phone, so that the mobile phone can use the miniSD memory card 60 for storing data.

In FIG. 2, the movable lift-up lid 30 of the miniSD memory card connector 10 is lifted first, and the miniSD memory card 60 can be inserted into the drawer type space of the movable lift-up lid 30 at any angle until the wedge-shape surface 62 of the miniSD memory card 60 touches the right blocking panel 34 of the movable lift-up lid 30. Then, the movable lift-up lid 30 is closed downward to electrically connect the signal contact section 61 of the miniSD memory card 60 with the terminal pins 40 of the insulating body 20, and then the movable lift-up lid 30 together with the miniSD memory card 60 are pushed forward, such that the right latch board panel 36 and the left latch board 37 of the movable lift-up board 30 are latched by the miniSD memory card connector 10 to provide an effect of fixing the movable lift-up lid 30 in place and electrically connect the signal contact section 61 of the miniSD memory card 60 with the terminal pins 40 of the miniSD memory card connector 10, so that the mobile phone is provided with multimedia functions including digital camera, video retrieval, MP3 playback and Internet communications.

A second preferred embodiment of the present invention is an embodiment including the foregoing first embodiment and all other embodiments related to the first embodiment and the improvement by adding a detector for detecting and confirming whether or not a miniSD memory card 60 is inserted into the miniSD memory card connector 10 and whether or not the installed miniSD memory card 60 is operated normally.

Further, for simplicity, the device numerals used for the description of the components of the second preferred embodiment adopts the device numerals for the description of the same or similar components used in the first preferred embodiment.

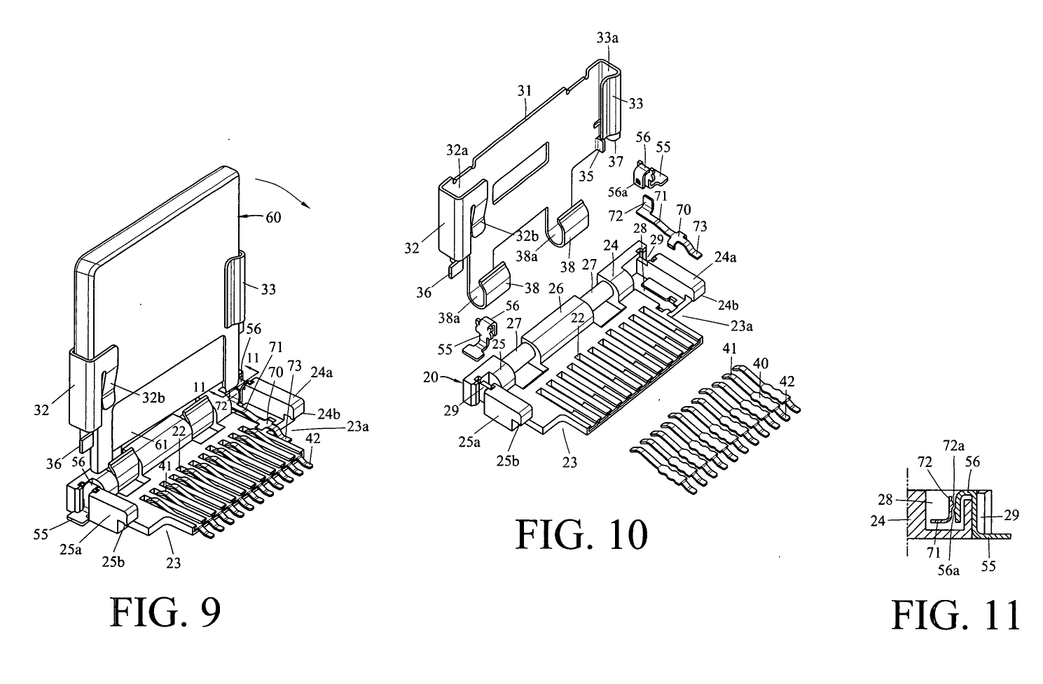

The miniSD memory card connector 10 as shown in FIGS. 9 to 12 is the miniSD memory card connector 10 of the second preferred embodiment of the present invention which comprises an insulating body 20, a movable lift-up lid 30 having a draw function for placing a miniSD memory card 60, eleven terminal pins 40 and a detector terminal 70.

After a miniSD memory card 60 is inserted into the movable lift-up lid 30 and both are closed and fixed in place as shown in FIG. 11, eleven signal lines of the signal contact section 61 of the miniSD memory card 60 will be electrically connect with the eleven terminal pins 40 of the insulating body 20.

As to the detailed structure of each component used in the second preferred embodiment of the present invention, the basic architecture, shape, structure, and functions adopt those of the first preferred embodiment. Therefore, any description the same as or similar to the description in the first preferred embodiment will refer to or cite the previously described contents, and thus such sections will not be described again.

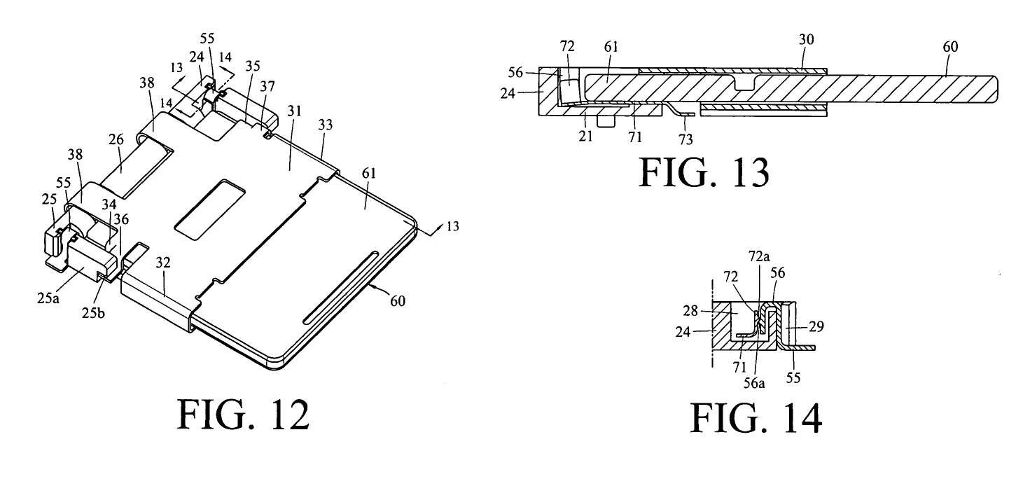

Referring to FIGS. 9 to 11, an opening 23 is defined at the front section of the right side of the substrate 21 of the insulating body 20 and another opening 23a is defined at the front section of the left side of the substrate 21, but the depth of the hollow area of the opening 23a disposed at the front section of the left side of the substrate 21 is deeper than the opening 21 at the front section of the right side, so that the hollow area of the opening 23a is provided for a pin section 73 of a detector terminal 70 to be protruded inside as shown in FIG. 12. After the movable lift-up lid 30 is closed such that the inverted L-shaped right bending board 32 and left bending board 33 panel disposed on both sides of the movable lift-up lid 30 having the drawer function will not collide with the surface of the substrate 21 of the insulating body 20 and move back and forth in the space of the opening 23a and the opening 23 on both sides of the substrate 21. In other words, the movable lift-up lid 30 is pushed forward or pulled backward as indicated by the arrow direction of the figures.

In FIGS. 9 and 10, the substrate 21 of the insulating body 20 has eleven slots 22 on its surface for receiving eleven terminal pins 40, and also has a slot 28 disposed on the surface of the substrate 21 at a position under the surface of the substrate 21 corresponding to the opening 23a at the surface of the substrate 21 for receiving a detector terminal 70.

The detector terminal 70 comprises a bending section 71, an electric contact section 72 and a pin section 73; wherein the bending section constitutes the front section of the detector terminal 70, and the middle of the bending section 71 is an upwardly curved protrusion, and the pin section 73 of the detector terminal 70 are coupled integrally with the front and the rear of the bending section 71 to define the rear section of the terminal pin 73.

The electric contact section 72 is a vertical panel coupled to a side at the front end of the bending section 71. In other words, a lateral side of the front end of the bending section 71 is extended towards one side first and then bent upward to define the vertical panel.

After the detector terminal 70 is embedded into the slot 28 of the substrate 21 of the insulating body 20, the front section of the bending section 71 of the detector terminal 70 is protruded from the surface of the substrate 21 as shown in FIG. 9 and keeps its resilience. The pin section 73 of the detector terminal 70 is extended into the opening 23a of the insulating body 20, and the vertical panel of the electric contact section is roughly parallel to the groove of the slot 28.

In addition, to enhance the electric contact effect of the electric contact section 72 as shown in FIG. 11, a contact member 72a is protruded from the vertical panel of the electric contact section 72 of the detector terminal 70 to constitute a preferred embodiment according to the second preferred embodiment.

Referring to FIGS. 9 and 10, a slot 29 is disposed individually on the left platform 24 and the right platform 25 of the insulating body 20 for inserting a lock plate 55 to electrically connect the vertical panel of the electric contact section 72 of the detector terminal 70 to detect and confirm whether or not a miniSD memory card 60 is inserted into the lift-up miniSD memory card connector 10 and whether or not the inserted miniSD memory card 60 is operated normally.

In FIGS. 9 and 11, if no miniSD memory card 60 is installed in the movable lift-up lid 30 of the miniSD memory card connector 10, or if the movable lift-up lid 30 has inserted a miniSD memory card 60 but the movable lift-up lid 30 and the inserted miniSD memory card 60 are not closed and placed in the normal position, the miniSD memory card connector 10 according to the second preferred embodiment of the present invention reserves a gap between the electric contact section 72 of the detector terminal 70 and the lock plate 55 disposed on the left platform 24, and default as not electrically connected, and thus no electric connection signal will be sent out.

Therefore, the foregoing detector terminal 70 is not electrically connected with the lock plate 55, and the miniSD memory card connector 10 is indicated as being in the status of having no miniSD memory card 60 connected.

In FIGS. 9 and 12, after the miniSD memory card 60 is inserted correctly into the movable lift-up lid 30 of the miniSD memory card connector 10 and the movable lift-up lid 30 and the inserted miniSD memory card 60 are closed and mounted into the correct position, the signal contact section 61 of the inserted miniSD memory card 60 as shown in FIGS. 13 and 14 will press on the bending section 71 of the detector terminal 70 protruded out of the surface of the substrate 21 and the bending section 71 of the detector terminal 70 can keep its resilience, and thus will be pressed downward to drive the electric contact section 72 of the detector terminal 70 to move downward, and electrically connect the lock plate 55 disposed on the left platform 24.

Therefore, the detector terminal 70 of the miniSD memory card connector 10 is electrically connected with the lock plate 55 to send out an electric connection signal to indicate that a miniSD memory card 60 is inserted into the miniSD memory card connector 10 and the inserted miniSD memory card 60 is operated normally.

Further, for enhancing the effect of electrically connecting with the electric contact section 72 of the detector terminal 70, the lock plate 55 on the left platform 24 is provided with a latch board 56 as shown in FIG. 11. In other words, the latch board 56 of the lock plate 55 has a vertical panel on which surface has a contact member 56a protruded from the surface, and which contact member 56a of the lock plate 55 shall be electrically connected with the contact member 72a of the detector terminal 70 to constitute an embodiment according to the second preferred embodiment of the present invention.

If the miniSD memory card connector 10 according to the second preferred embodiment of the present invention is in use, the pin section 42 at the rear section of the terminal pin 40, the pin section 73 at the rear section of the detector terminal 70, and the lock plate 55 disposed on both sides of the insulating body 20 are soldered on the circuit board first. In addition to fixing the miniSD memory card connector 10 in place, the circuit of the detector terminal 70 and the lock plate 55 on the circuit board defines a detection circuit.

Therefore, the miniSD memory card connector 10 according to the second preferred embodiment of the present invention shall have the functions and effects of the first preferred embodiment and also has the functions of detecting and confirming whether or not a miniSD memory card 60 is inserted and whether or not the inserted miniSD memory card 60 is operated normally. When a mobile phone is in use, the mobile phone may detect the miniSD memory card 60 in addition to having the multimedia functions.

1. A lift-up miniSD memory card connector, comprising an insulating body, a movable lift-up lid and a plurality of terminal pins; wherein
said insulating body having a board-shaped substrate, and said substrate having a slot disposed at its surface for inserting said terminal pins and three platforms being coupled to a platform and protruded from the rear side of said substrate;
said movable lift-up lid having a cover asymmetric on both sides, and said cover having an L-shaped bending board disposed at the front section on each of both sides of said cover to define a drawer-type space of said cover, a blocking panel protruded vertically downward and disposed at the middle section of each of both sides of said cover and one of said blocking panels being disposed deeper into the surface of said cover; two hook brackets being protruded from the bottom corresponding to a position of said axle rod of said insulating body and pivotally coupled to the axle rod of said insulating body; and
plurality of terminal pins being inserted into the surface of said substrate of said insulating body such that each pin of said terminal pins is protruded to the outside.

2. The lift-up miniSD memory card connector of claim 1, wherein said L-shaped bending board defining said movable lift-up lid having said drawer type space comprises a slightly curved press board at the surface of said horizontal board.

3. The lift-up miniSD memory card connector of claim 1, wherein said platform disposed on both sides of said insulating body comprises a first bracket and a second bracket protruded forwardly having a different thickness, and a rib protruded downwardly and disposed at the front end of the bottom of each said bracket, and a L-shaped latch board protruded downward and disposed at the rear section of both sides of said cover of said movable lift-up lid.

4. The lift-up miniSD memory card connector of claim 2, wherein said platform disposed on both sides of said insulating body comprises a first bracket and a second bracket protruded forwardly having a different thickness, and a rib protruded downwardly and disposed at the front end of the bottom of each said bracket, and a L-shaped latch board protruded downward and disposed at the rear section of both sides of said cover of said movable lift-up lid.

5. The lift-up miniSD memory card connector of claim 3, wherein a latch board of said movable lift-up lid comprises a tenon rib disposed on the surface of a horizontal plate to define a coupling structure with a corresponding rib of said insulating body.

6. The lift-up miniSD memory card connector of claim 4, wherein a latch board of said movable lift-up lid comprises a tenon rib disposed on the surface of a horizontal plate to define a coupling structure with a corresponding rib of said insulating body.

7. The lift-up miniSD memory card connector of claim 1, wherein said insulating body comprises a slot disposed on each of both sides of said insulating body for inserting a lock plate therein.

8. The lift-up miniSD memory card connector of claim 1, wherein said cover of said movable lift-up lid comprises a blocking panel protruded downward and disposed at the rear section of both sides of said cover.

9. The lift-up miniSD memory card connector of claim 1, wherein said blocking panel and latch board disposed on both sides of said cover of said movable lift-up lid are coupled integrally.

10. A lift-up miniSD memory card connector, comprising an insulating body, a movable lift-up lid, a plurality of terminal pins, and a detector terminal; wherein
said insulating body having a board-shaped substrate, and said substrate having a slot disposed at its surface for inserting said terminal pins and three platforms being coupled to a platform and protruded from the rear side of said substrate;
said movable lift-up lid having a cover asymmetric on both sides, and said cover having an L-shaped bending board disposed at the front section on each of both sides of said cover to define a drawer-type space of said cover, a blocking panel protruded vertically downward and disposed at the middle section of each of both sides of said cover and one of said blocking panels being disposed deeper into the surface of said cover; two hook brackets being protruded from the bottom corresponding to a position of said axle rod of said insulating body and pivotally coupled to the axle rod of said insulating body;
plurality of terminal pins being inserted into the surface of said substrate of said insulating body such that each pin of said terminal pins is protruded to the outside; and
said detector terminal disposed on the surface of said substrate of said insulating body, comprising a bending section, an electrically contact section and a pin section, wherein said bending section is a protrusion protruded from the surface of said substrate and keeps its resilience; said pin section is protruded out of said substrate of said insulating body; and said electrically contact section is a vertical panel coupled to a lateral edge of a front end of said bending section.

11. The lift-up miniSD memory card connector of claim 10, wherein said L-shaped bending board defining said movable lift-up lid having said drawer type space comprises a slightly curved press board at the surface of said horizontal board.

12. The lift-up miniSD memory card connector of claim 10, wherein said platform disposed on both sides of said insulating body comprises a first bracket and a second bracket protruded forwardly having a different thickness, and a rib protruded downwardly and disposed at the front end of the bottom of each said bracket, and a L-shaped latch board protruded downward and disposed at the rear section of both sides of said cover of said movable lift-up lid.

13. The lift-up miniSD memory card connector of claim 11, wherein said platform disposed on both sides of said insulating body comprises a first bracket and a second bracket protruded forwardly having a different thickness, and a rib protruded downwardly and disposed at the front end of the bottom of each said bracket, and a L-shaped latch board protruded downward and disposed at the rear section of both sides of said cover of said movable lift-up lid.

14. The lift-up miniSD memory card connector of claim 12, wherein a latch board of said movable lift-up lid comprises a tenon rib disposed on the surface of a horizontal plate to define a coupling structure with a corresponding rib of said insulating body.

15. The lift-up miniSD memory card connector of claim 13, wherein a latch board of said movable lift-up lid comprises a tenon rib disposed on the surface of a horizontal plate to define a coupling structure with a corresponding rib of said insulating body.

16. The lift-up miniSD memory card connector of claim 10, wherein said substrate of said insulating body comprises an opening disposed on both sides of said substrate.

17. The lift-up miniSD memory card connector of claim 10, wherein said insulating body comprises a slot disposed on each of both sides of said insulating body for inserting a lock plate therein.

18. The lift-up miniSD memory card connector of claim 10, wherein said cover of said movable lift-up lid comprises a blocking panel protruded downward and disposed at the rear section of both sides of said cover.

19. The lift-up miniSD memory card connector of claim 10, wherein said blocking panel and latch board disposed on both sides of said cover of said movable lift-up lid are coupled integrally.

20. The lift-up miniSD memory card connector of claim 16, wherein the lock plate has a protruded contact member, and the detector terminal has a corresponding contact member protruded from the vertical panel of the electric contact section of the detector terminal.
